(19) United States
(12) Patent Application Publication
(10) Pub. No.: US 2014/0320077 A1
(43) Pub. Date: Oct. 30, 2014

(54) CHARGING SYSTEM AND METHOD

(71) Applicant: TENCENT TECHNOLOGY (SHENZHEN) COMPANY LIMITED, Shenzhen (CN)

(72) Inventor: Liangjun LUO, Shenzhen (CN)

(21) Appl. No.: 14/327,931

(22) Filed: Jul. 10, 2014

Related U.S. Application Data
(63) Continuation of application No. PCT/CN2014/070010, filed on Jan. 2, 2014.

(30) Foreign Application Priority Data
Mar. 26, 2013 (CN) 201310100990.1

(51) Int. Cl. H02J 7/02; H02J 7/00

(52) U.S. Cl. CPC H02J 7/025; H02J 7/0029; H02J 7/007
USPC 320/108; 320/137; 320/162

(57) ABSTRACT

The present invention is applied to the field of charging technology and provides a charging system and a charging method, and the charging system includes a first means provided with a magnetic medium and a second means for sensing and transforming a magnetic flux change into electrical power, and the second means is provided with a charging protective circuit limiting the electrical power and a charging interface for connecting to a device to be charged, and the charging protective circuit is connected with the charging interface. The magnetic flux in the second means is changed when the first means and the second means are moved relative to each other, and the magnetic flux change is transformed into electrical power by the second means. Through the charging interface, the electrical power is transferred to the external device to be charged. The embodiments of the present invention overcome the impact on the endurance ability of the mobile device that is caused by the limited battery capacity, thereby improving the endurance ability of the mobile device, even actually achieving the permanent endurance ability.

This application claims priority to and is a continuation of PCT/CN2014/070010, filed on Jan. 2, 2014 and entitled “CHARGING SYSTEM AND METHOD”, which claims the benefit of Chinese Patent Application No. 201310100990.1, filed with the Chinese Patent Office on Mar. 26, 2013 and titled “CHARGING SYSTEM AND METHOD”, the contents of which are incorporated herein by reference in their entirety.

### TECHNICAL FIELD

The present invention relates to the field of power supply, in particular to a charging system and a charging method.

### TECHNICAL BACKGROUND

With the popularization of mobile devices, users are more and more demanding for power supplies for the mobile devices. On one hand, it has been attempted to enlarge the battery capacity in order for providing a long-lasting battery for the mobile device; on the other hand, a mobile power supply for the mobile device has been developed, so that the battery of the mobile device can be charged by an additional mobile power supply carried with the user, thereby prolonging the outdoor service time of the mobile device.

However, the enlargement of the capacity of the existing mobile power supply or the existing battery of the mobile device generally requires for increasing the volume and the weight of the mobile power supply or the battery, leading to carrying inconvenience; further, the service time of the mobile device cannot be prolonged very much, that is, the technical problem of improving the endurance ability of the battery is not indeed solved.

### SUMMARY OF THE INVENTION

Embodiments of the present invention provide a charging system and a charging method, to solve the problem of the undurable endurance ability of the battery charged by the mobile power supply in the prior art.

Technical solutions adopted by the embodiments of the present invention are as follows.

A charging system includes a first means provided with a magnetic medium; and a second means used for sensing and transforming a magnetic flux change into electrical power, wherein the second means is provided with a charging protective circuit for limiting the electrical power and a charging interface for connecting to a device to be charged, and the charging protective circuit is connected with the charging interface.

A charging method, includes:

reciprocatingly moving a first means and a second means relative to each other, so that a magnetic flux in the second means, that is caused when magnetic induction lines generated by the first means pass through the second means, changes, wherein the first means is provided with a magnetic medium; and

transforming, by the second means, the sensed magnetic flux change into electrical power, which is then transferred to a charging interface through a charging protective circuit limiting the electrical power and is received by a device to be charged.

In the embodiments of the present invention, the magnetic induction lines generated by the first means are cut by the second means when the first means and the second means are moved relative to each other, thus the magnetic flux is changed in the second means, and the magnetic flux change is transformed by the second means into electrical power which is transferred to the charging interface through the charging protective circuit, and hence is transferred from the charging interface to the external device to be charged. Since the electrical power is generated through the reciprocated motion of the first means and the second means relative to each other according to the embodiments of the present invention, to overcome the impact on the endurance ability of the mobile device that is caused by the limited battery capacity, thereby improving the endurance ability of the mobile device, even actually achieving the permanent endurance ability.

### DESCRIPTION OF DRAWINGS

FIG. 1 is a schematic view showing the structure of the charging system according to a first embodiment of the present invention;

FIG. 2 is a schematic view showing the charging scene using a first means and a second means respectively carried on the arm and the waist of the user according to the first embodiment of the invention;

FIG. 3 is a schematic side view showing the structure of the second means according to the first embodiment; and

FIG. 4 is a schematic view showing the structure of the charging system according to a second embodiment of the present invention.

### DETAILED DESCRIPTION OF THE PREFERRED EMBODIMENTS

The present invention are further described in conjunction with the accompanying drawings and the embodiments so as to make the solutions and advantages of the present invention more apparent. It should be understood that, the embodiments described herein are only to explain the present invention and are not intended to be limit, the present invention.

In the embodiments of the present invention, the charging system includes: a first means with a magnetic medium; and a second means, which senses and transforms a magnetic flux change into electrical power, and is provided with a charging protective circuit limiting the electrical power and a charging interface used to connect a device for charging, where the charging protective circuit is connected to the charging interface. Due to the relative movement between the first means and the second means, magnetic induction lines generated by the first means are cut by the second means, and the second means transforms the magnetic flux change into electrical power, which is transferred to the charging interface through the charging protective circuit to charge the device to be charged. Since the charging is implemented merely by the relative movement between the first means and the second means, it is possible to charge the device in a long-lasting manner through the relative movement between the first and second means, so that the device is not limited by the battery capacity.

### First Embodiment

FIG. 1 is a schematic view showing the structure of the charging system according to the first embodiment of the present invention. The charging system is described in detail as follows:

According to the embodiment of the present invention, the charging system includes: a first means 101 with a magnetic medium; and a second means 102, which senses and transforms a magnetic flux change into electrical power, and is provided with a charging protective circuit 103 limiting the electrical power obtained from the transformation and a charging interface 104 used to connect a device for charging, where the charging protective circuit 103 is connected to the charging interface 104.

To form the first means 101 provided with the magnetic medium, in this embodiment of the present invention, a magnetic material or other means for generating the magnetic induction lines can be arranged in the first means, for example, the first means 101 is formed by arranging a Neodymium magnet in a permanent magnet. A strong magnetic field can be generated by the first means even if the first means contains a small volume or amount of Neodymium magnet, because the Neodymium magnet is featured by very strong magnetism, so that a large magnetic flux change and hence a large electric current are caused when the second means cuts the magnetic induction lines generated by the first means, thus the charging of the device to be charged can be completed quickly and efficiently.

As a possible implementation, the first means may be formed by a magnetic ring, which has an integrative structure or is configured by two attracting magnetic half rings each with opposite polarities. The first means 101, if designed as a magnetic ring, can be conveniently worn on the arm or foot of a user, thus the first means 101 is moved continuously during the natural motions of the user (such as the motions of the foot or arm when the user is walking). If the first means 101 is configured by two magnetic half rings with opposite polarities, the size of the ring formed by the two magnetic half rings can be adjusted conveniently by the user wearing the first means.

The second means 102 is configured for sensing and transforming the magnetic flux change into electrical power. In this embodiment, a coil is arranged in the second means 102, and preferably a multi-turn coil is arranged in the second means 102 to increase the inductive sensitivity and the current strength.

The second means 102 is provided with a charging protective circuit 1021 which limits the electrical power obtained from the transformation and a charging interface 1022 which is used to connect the device to be charged, and the charging protective circuit 1021 is connected with the charging interface 1022. The charging protective circuit 1021 generally includes a current-limiting protective circuit, an overcurrent protective circuit, an overvoltage protective circuit and a voltage-stabilizing circuit, the structures of which or circuit chips thereof are not described in detail herein.

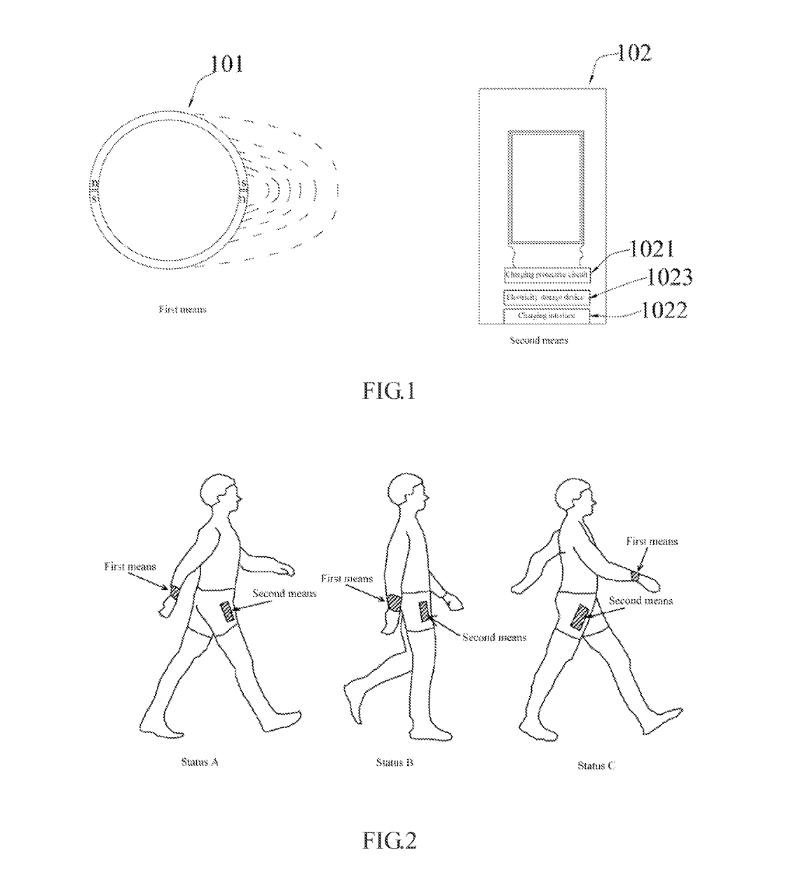

In order to be carried conveniently or operated simply, the first means and the second means are designed separately, to facilitate the operations by the user. FIG. 2 is a schematic view showing the charging scene using the first means and the second means respectively carried on the arm and the waist of the user, where, the first means has a ring-shaped structure and may be arranged on the wrist of the user, and the second means may be placed in the pocket at the waist or arranged on a belt of the user by a buckle on the second means. As shown in FIG. 2, in the case of a status A where the user's arm is elevated, the first means is far away from the second means, and the magnetic flux in the coil of the second means caused by the magnetic induction lines generated by the first means is small. In the case of a status B where the user's arm falls adjacent to the second means on the waist, magnetic induction lines of a high density generated by the first means pass through the second means such that the magnetic flux in the coil of the second means is large. In the case of a status C where the first means is far away from the second means again, the magnetic flux in the coil of the second means caused by the magnetic induction lines generated by the first means is small again. In this way, the magnetic flux in the coil of the second means changes continuously to generate the current, which is transferred to the charging interface through the charging protective circuit, so that the device connected to the charging interface can be charged.

Of course, an illustrative way of wearing the first and second means is illustrated in this embodiment, but the first means and/or the second means may be provided with a wearing part to be worn on the foot or the wrist of the user; or the first means and/or the second means may have a shape suitable for wearing on the foot or wrist of the user. Therefore, the first means and the second means can be worn on the arms or feet, or on the arm and the waist of the user.

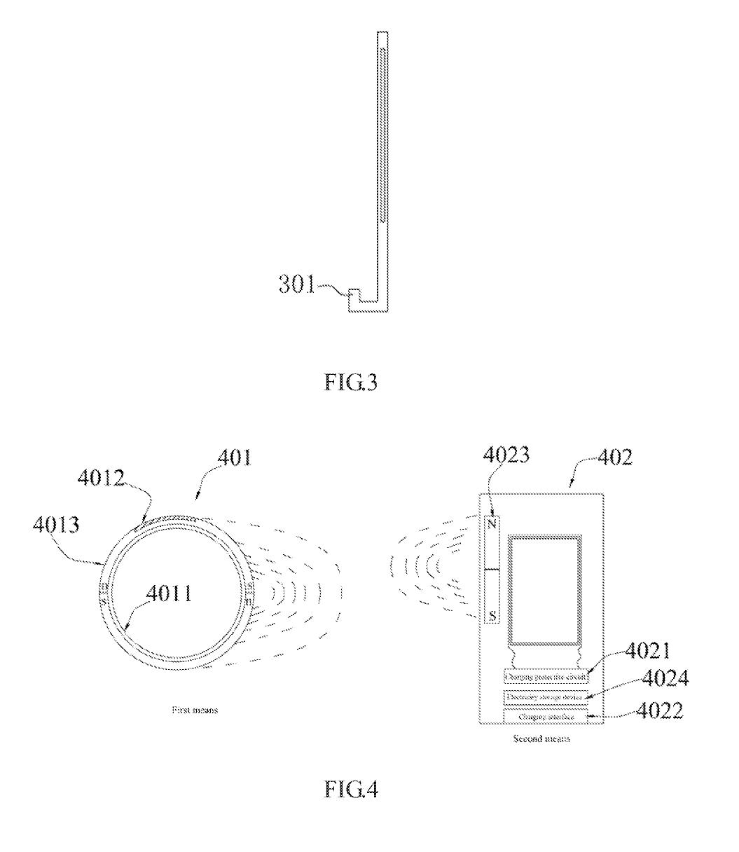

FIG. 3 is a schematic side view showing the structure of the second means according to the first embodiment. The integrated structure at the bottom of the second means includes a hook-shaped charging interface 301 where the device to be charged can be directly placed. Of course, the charging interface may be L-shaped, and the device to be charged is fixed to the L-shaped charging interface for the sake of easy carrying and charging operations.

As an improvement of this embodiment of the present invention, the charging protective circuit is also connected to an electricity storage device 1023, which may be a rechargeable battery or an accumulator and is configured to charge the device to be charged by setting or adjusting the output voltage of the electricity storage device.

According to this embodiment, the first means is arranged to generate the magnetic induction lines and the second means is arranged to sense and transform the magnetic flux change into the current, so that the current is generated by the relative motion between the first means and the second means, and hence the device to be charged is charged through the charging protective circuit and the charging interface. In this way, it is possible to enable the long-lasting endurance ability of the device to be charged, thereby actually achieving the permanent charging.

### Second Embodiment

FIG. 4 is a schematic view showing the structure of the charging system according to the second embodiment of the present invention, and the charging system is described in detail as follows.

The charging system includes: a first means 401 provided with a magnetic medium 4013, and a second means 402 configured to sense and transform a magnetic flux change into electrical power, and the second means 402 is provided with a charging protective circuit 4021 limiting the electrical power obtained from the transformation and a charging interface 4022 for connecting to a device to be charged, where the charging protective circuit 4021 is connected to the charging interface 4022. Moreover, the first means may also include an electrical power conversion circuit 4011 for sensing and transforming a magnetic flux change into electrical power and a display device 4012 connected to the electrical power conversion circuit 4011, and the second means also includes a magnetic medium 4023.

The second embodiment is different from the first embodiment in that: the electrical power conversion circuit 4011 is further arranged on the first means 401 to sense and transform the magnetic flux change into electrical power. The electrical power conversion circuit 4011 may have a structure similar to the structure of the coil arranged in the second means 402; correspondingly, a magnetic material such as a magnet is provided in the second means 402 just like in the first means 401, in order to generate the current in the coil of the first means 401. In this way, the magnetic flux in the coil of the first means 401 changes due to the relative motion between the first means and the second means, so that the current is generated in the coil to enable the display by the display device 4012. The display device 4012 may be a display screen, or an LED light. The brightness level of the LED light indicates the current strength of the current generated in the charging device. Given that little current is needed for the displaying of the display device 4012, a coil with a small number of turns is arranged in the first means to reduce the costs and decrease the weight of the device for the sake of improved portability.

As a preferable implementation of this embodiment of the present invention, the first means 401 is also provided with a current intensity detection device. The display device 4012 is connected to the current intensity detection device to display the information of the current intensity detected by the current intensity detection device. After the current intensity is detected by the current intensity detection device, a value of the current intensity is displayed by the display device 4012. Unlike the case that the present current intensity is displayed by the brightness level of the LED light, after the strength of the current generated by the first means is detected by the current intensity detection device, based on the ratio of the current generated in the coil of the first means 401 to that generated in the coil of the second means 402 that is obtained from the ratio of the coils in the first means and the second means as well as the magnetism thereof, the magnitude of the current generated in the second means 402 is obtained according to the magnitude of the current generated in the first means 401 and then recorded more conveniently.

In order to facilitate the usage, the second means 402 further includes an electricity storage device 4024 which is connected to the charging protective circuit 4021 and the charging interface 4022. The electricity storage device 4024 may be an accumulator or other rechargeable batteries and is charged during the ordinary motion of the user, so that the device to be charged may be directly charged by the electricity storage device 4024 as desired.

The other part of this embodiment is the same as that of the first embodiment, and hence is not described repeatedly herein.

Since the inductive coil is introduced in the first means 401 and the magnetic material is additionally arranged in the second means according to this embodiment of the present invention, the electrical power can also be generated in the first means 401 and the present current strength is displayed by the display device, thereby providing a visual charging indication for the user.

### Third Embodiment

This embodiment provides a charging method based on the charging system described in the above two embodiments, the method is described in detail as follows.

The charging method corresponding to the charging system in the first embodiment includes that: the first means and the second means are moved reciprocatingly relative to each other, so that the magnetic flux in the second means, which is caused when the magnetic induction lines generated by the first means pass through the second means, changes, and the sensed magnetic flux change is transformed into electrical power which is then transferred to the charging interface through the charging protective circuit, so that the electrical power is received by the device to be charged.

When the charging system further includes an electricity storage device, the method further includes that:

the electrical power is stored in the electricity storage device of the second means, and the stored power is transferred from the electricity storage device to the device to be charged as desired.

In the charging system disclosed in the second embodiment, the first means further includes the electrical power conversion circuit for sensing and transforming the magnetic flux change into electrical power and the display device connected to the electrical power conversion circuit, and the second means further includes the magnetic medium, accordingly the charging method further includes that: the first means and the second means are reciprocatingly moved relative to each other, so that the magnetic induction lines of the second means pass through the first means, and the magnetic flux change of the first means is transformed into electrical power by the first means to drive the display device.

Moreover, when the charging system further includes the current density detection device, the method further includes that:

the current strength of the electrical power obtained from the transformation by the first means is detected by the current density detection device, and is displayed by the display device.

In order to charge the external device by the first means and the second means conveniently, the first means and the second means are worn on the arms or the feet, or on the arm and the waist, so that the first means and the second means may be moved relative to each other due to the natural motion of the user, thereby causing the magnetic flux change in the second means and hence generating the electrical power in the second means to charge the external device.

Moreover, if a plurality of users wear the first means and the second means of the present invention, the second means may cut more magnetic induction lines due to the changes of magnetic fields generated by these first means worn on the users, to cause a large magnetic flux change and obtain much electrical power, so as to meet the charging requirement of the device to be charged.

This embodiment provides charging methods corresponding to the first embodiment and the second embodiment, and the advantages of this embodiment are similar to those in the first embodiment and the second embodiment and are not described in detail herein.

The embodiments of the present invention mentioned above are preferable embodiments, but are not intended to limit the present invention. All these modifications, substitutions and improvements made without departing from the scope of the invention are intended to fall in the scope of the present invention.

1. A charging system, comprising:
a first means provided with a magnetic medium; and
a second means used for sensing and transforming a magnetic flux change into electrical power, wherein the second means is provided with a charging protective circuit for limiting the electrical power and a charging interface for connecting to a device to be charged, and the charging protective circuit is connected with the charging interface.

2. The charging system of claim 1, further comprising an electricity storage device connected to the charging protective circuit and the charging interface.

3. The charging system of claim 1, wherein, the first means further comprises an electrical power conversion circuit for sensing and transforming a magnetic flux change into electrical power and a display device connected to the electrical power conversion circuit, and the second means further comprises a magnetic medium.

4. The charging system of claim 3, wherein, the first means is further provided with a current strength detection device connected to the display device, and the display device is further used to display information of the current strength detected by the current strength detection device.

5. The charging system of claim 1, wherein, at least one of the first means and the second means is further provided with a wearing part which is worn on the foot or the wrist of a user; or
at least one of the first means and the second means has a shape suitable for wearing on the foot or the wrist of the user.

6. A charging method, comprising:
reciprocatingly moving a first means and a second means relative to each other, so that a magnetic flux in the second means, that is caused when magnetic induction lines generated by the first means pass through the second means, changes, wherein the first means is provided with a magnetic medium; and
transforming, by the second means, the sensed magnetic flux change into electrical power, which is then transferred to a charging interface through a charging protective circuit limiting the electrical power and is received by a device to be charged.

7. The charging method of claim 6, further comprising: storing the electrical power in an electricity storage device.

8. The charging method of claim 6, wherein:
the first means further comprises an electrical power conversion circuit and a display device connected to the electrical power conversion circuit, and the second means further comprises a magnetic medium, so that magnetic induction lines generated by the second means pass through the first means, and the first means transforms a magnetic flux in the first means into electrical power to drive the display device.

9. The charging method of claim 7, further comprising:
detecting, by a current strength detection device, the current strength of the electrical power obtained from the transformation by the first means, and displaying the detected current strength by the display device.

10. The charging method of claim 6, wherein, the first means and the second means are respectively worn on the arms, on the feet, or on an arm and the waist of a user.

11. The charging system of claim 2, wherein, at least one of the first means and the second means is further provided with a wearing part which is worn on the foot or the wrist of a user; or
at least one of the first means and the second means has a shape suitable for wearing on the foot or the wrist of the user.

12. The charging system of claim 3, wherein, at least one of the first means and the second means is further provided with a wearing part which is worn on the foot or the wrist of a user; or
at least one of the first means and the second means has a shape suitable for wearing on the foot or the wrist of the user.

13. The charging method of claim 7, wherein, the first means and the second means are respectively worn on the arms, on the feet, or on an arm and the waist of a user.

14. The charging method of claim 8, wherein, the first means and the second means are respectively worn on the arms, on the feet, or on an arm and the waist of a user.
